(19) United States
(12) Patent Application Publication
(10) Pub. No.: US 2009/0271261 A1
(43) Pub. Date: Oct. 29, 2009

(54) Policy driven customer advertising

(76) Inventors: Neerav Mehta, Edison, NJ (US); Paritosh Bajpay, Edison, NJ (US)

Correspondence Address: AT& T LEGAL DEPARTMENT - Monka;ATTN: PATENT DOCKETING, ROOM 2A - 207, ONE AT & T WAY, BEDMINSTER, NJ, 07921, US

(21) Appl. No.: 12/150,033

(22) Filed: Apr. 24, 2008

(51) Int. Cl. G06Q 30/00; G06F 17/30; H04N 7/173; H04Q 7/22

(52) U.S. Cl. 705/14; 725/24; 455/414.3

(57) ABSTRACT

A system and methodology for providing policy driven, user requested advertising is disclosed. Networked users may be provided with selected advertisements to a targeted network access device during a specified broadcast event based on user preferences. The system includes a computing device coupled to at least one communications network and adapted for: receiving user preferences comprising desired advertising content, and specified network access device information for receiving and displaying the advertising thereon. The user preferences are stored in a database and matched to the user preferences with advertising content by at least one advertiser during the specified broadcast event. The advertisements that meet the user preferences are thereafter communicated over at least one communications network to at least one network access device specified in the user selected preferences.

### FIELD OF THE INVENTION

The present invention relates generally to multimedia advertising distribution, and more particularly, to systems and methods for providing policy driven, user requested business-to-consumer (B2C) and business-to-business (B2B) advertising.

### BACKGROUND OF THE INVENTION

Advertising is a very important communication medium in which information is conveyed on a mass scale in a variety of formats to a variety of recipients. Advertising is generally defined as a communication with a variety of purposes including informing potential customers about products and services, and how to obtain and use them. Many advertisements are also intended to generate increased interest and consumption of those products and services through the creation and reinforcement of brand image and brand loyalty. Advertising is also used by non-for-profit (i.e., the Museum of Modem Art, the American Red Cross, Cancer Society, etc.), government organizations (U.S. Army/Navy/Air Force) and various political organizations for a variety of purposes, including soliciting donations, looking for recruits and furthering a political party's platform. Hereinafter, the term “advertising” is intended to refer to all mass and customized communications by any organization or entity, for any purpose.

Advertisers use a variety of mediums to deliver their messages, including (but not limited to) television, radio, movies, magazines, newspapers, videogames, billboards and the Internet. While advertising is often seen as necessary for economic growth, it is not without social costs. The cost of “free” (to the consumer) television and radio is actually paid for by the advertisers or sponsors of the advertising content. Organizations spend millions, and in some cases billions of dollars to create, maintain and grow their business by establishing product or brand identity and marketing it to individuals and businesses. Network Access Devices (NADs) connected to the Internet or other networks provide a relatively new medium for delivering advertising message content to the masses. NADs may include, but are not limited to, devices such as personal or laptop computers, internet TV, cable TV, VoIP telephony, landline telephones, cell phones, Personal Digital Assistants (PDAs), and dashtop (automotive) devices, and other emergent devices for general use.

Internet marketing, also referred to as online marketing or Emarketing, is the marketing of products and/or services over the Internet. The Internet has facilitated the global distribution of products and services via a NAD (i.e., data, music file, software, reports, surveys, blogs, . . . ). The interactive nature of Internet marketing, both in terms of instant response and in eliciting response, are distinctive qualities of the medium. Internet marketing ties together creative and technical aspects of the Internet, including design, development, advertising and sales. Internet marketing methods include search engine marketing, display advertising, e-mail marketing, affiliate marketing, interactive advertising, online reputation management and Social Media Marketing Methods such as blog marketing, and viral marketing.

Mobile Marketing, as defined by marketing on or through a mobile device, such as a mobile phone or a PDA, is an evolving methodology for developing and expanding the reach of many businesses. Mobile advertising uses mobile phones and other mobile devices (Mobile-NADs) to deliver advertising content to users. Mobile phones, the term used in Europe, are referred to as cell or cellular phones in the United States. As used herein, the terms “cell phone” and “mobile phone” may be used interchangeably in referring to a mobile or cellular telephone. Marketing on a mobile phone has become increasingly popular since the rise of SMS (Short Message Service) in the early 2000s in Europe and some parts of Asia when businesses started to collect mobile phone numbers and send unwanted advertising content. The general term for unsolicited/unwanted/unrequested email messages is “spam”. This term is also used in reference to other unwanted advertisements in the form of a FAX, SMS message, voicemail, videomail and the like. Over the past few years SMS has become a legitimate advertising channel. This is due in large part that unlike email over the public Internet, the carriers who police their own networks (in this case, the SMS networks) have set guidelines and best practices for the mobile media industry, including mobile advertising and marketing. The Interactive Advertising Bureau and the Mobile Marketing Association, as well, have established guidelines for promoting the use of mobile devices for marketers. SMS initially received negative media coverage in many parts of Europe for being a new form of “spam” as some advertisers purchased lists and sent unsolicited messages to consumer's phones, however, as guidelines have been put in place by the mobile operators, SMS has become the most popular branch of the Mobile Marketing industry with several hundred million SMS advertising messages sent out every month in Europe alone. There are hundreds of mobile phone/PDA handsets and they differ by screen size and supported technologies.

The instantaneous nature of SMS messages also makes it ideal for silent (unobtrusive) communication between users, as opposed to an actual voice conversation. This can be useful in situations where voice conversation is discouraged or just not possible. For example, a quite environment were conversation is discouraged could be in a theater or in a waiting room. A loud environment where conversation is just not possible could be on a loud construction site or while outside during adverse weather conditions. The ability to send and receive SMS messages also makes this platform a gateway to viral marketing, as discussed below.

Viral marketing is another dimension of marketing which has seen explosive growth as a result of the Internet and NAD availability. Viral marketing and viral advertising refer to marketing techniques that use social networks to produce increases in brand awareness, through self-replicating viral processes, analogous to the spread of pathological and computer viruses. The Internet and NAD availability are the perfect facilitators to make viral marketing a quick, low-cost and effective marketing tool. This can be very helpful when the message is positive, but can be exceptionally destructive if the message is negative. It is claimed that a satisfied customer tells an average of three people about their experience while they tell eleven people when they are unsatisfied. Viral marketing is based on this observed human behavior. The goal of marketers interested in creating successful viral marketing programs is to identify individuals with high Social Networking Potential (SNP) and create viral messages that appeal to this segment of the population and have a high probability of being passed along.

Users of NADs are typically far too busy to allow “spam” to enter their consciousness, and tend to just throw unwanted messages away. By providing users with the ability to customize which type of messages are sent to their NAD of choice, the likelihood grabbing the user's attention could be increased dramatically. By combining specific NAD information for receiving and displaying advertising along with user preference, effective Internet marketing (and possibly mobile marketing or viral marketing) campaigns could be conducted.

It would therefore be desirable to provide systems and methods for customizing the presentation of advertising content to users, based on user-specific information, such as contact information (i.e. phone number or email address to be used for content delivery), events of interest (i.e. football championship game or blood drive), geographic area of interest (i.e. zip code, town or general area(s)), and desired NAD hardware to be used for advertising message content delivery (i.e. make/model of cell phone or PDA, or voicemail message).

### SUMMARY OF THE INVENTION

In accordance with a first aspect of the present invention, there is disclosed a method for providing advertising to users over at least one communications network during a specified broadcast event based on user preferences. The method generally comprises the steps of: receiving user preferences comprising desired advertising content, and specified network access device information for receiving and displaying the advertising thereon; storing the user preferences in a database; matching the user preferences with advertising content by at least one advertiser during the specified broadcast event; and communicating advertising content which meet the user preferences over at least one communications network to at least one network access device specified in the user selected preferences.

In accordance with a second aspect of the present invention, there is disclosed a system for providing advertising to networked users during a specified broadcast event based on user preferences. The system is comprised of a computing device coupled to at least one communications network and adapted for: receiving user preferences comprising desired advertising content, and specified network access device information for receiving and displaying the advertising thereon; storing the user preferences in a database; matching the user preferences with advertising content by at least one advertiser during the specified broadcast event; and communicating advertising content which meet the user preferences over at least one communications network to at least one network access device specified in the user selected preferences.

In accordance with a third aspect of the present invention, there is disclosed a system for providing advertising to networked users during a specified broadcast event based on user preferences. The system is comprised of a computing device coupled to at least one communications network and adapted for: receiving user preferences comprising desired advertising content, and specified network access device information for receiving and displaying the advertising thereon; storing the user preferences in a database; receiving advertising content from at least one advertiser; matching the user preferences with advertising content by the at least one advertiser during the specified broadcast event with a rules engine adapted for matching the user preferences with the advertising content and formatting an advertisement for the network access device specified in the user preferences; and communicating advertising content which meet the user preferences over at least one communications network to at least one network access device specified in the user selected preferences.

These aspects of the invention and further advantages thereof will become apparent to those skilled in the art as the present invention is described with particular reference to the accompanying drawings.

### BRIEF DESCRIPTION OF THE DRAWINGS

FIG. 1 is a functional block diagram embodiment of the system in accordance with an aspect of the present invention;

FIG. 2 is a flowchart depicting a method in accordance with an aspect of the present invention;

FIG. 3 is a functional block diagram of various computer system components for an exemplary implementation of a system in accordance with an aspect of the present invention; and

FIG. 4 is a functional block diagram of various network components for an exemplary implementation of a system in accordance with an aspect of the present invention.

### DESCRIPTION OF THE INVENTION

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention provides a system and method for enabling business-to-consumer (B2C) and business-to-business (B2B) advertising in a targeted manner in accordance with user specifications. In this regard, an organization (business, non-profit, government agency, or the like) may provide advertising during a specific broadcast event that is matched to user specified preferences including delivery information (i.e., a specific network access device (NAD) on which to receive the advertisement(s)). Advantageously, contact information (i.e., format, such as email, voicemail, instant message, television performance, java applet, etc.), event information (type of event for which they would like to receive targeted advertisements), geographic information (physical area(s) of interest regarding advertisements), etc., may be included in the user preferences. The system utilizes a networked computer/server environment to match the advertisers' content with the user preferences, and the matched content is then formatted and delivered to the selected NAD as set forth in the user preferences.

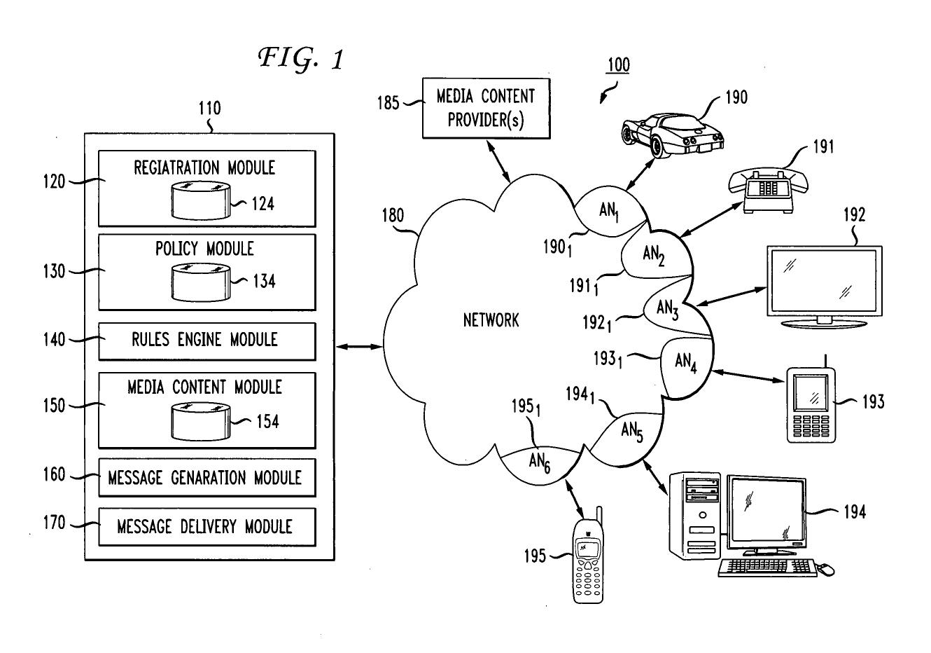

FIG. 1 is a high-level functional block diagram of a system 100 for implementing aspects of the present invention. The system includes at least one networked computing device 110, which comprises a plurality of modules: Registration module 120, policy module 130, rules engine module 140, media content module 150, message generation module 160 and message delivery module 170. The computing device 110 is coupled to a communications network (generically denoted by the reference numeral 180), and is adapted for communicating with media content provider(s) 185 (those providing the media (advertising) content) to receive advertisements therefrom, and (NADs) including but not limited to, in the illustrative application, a car 190, landline telephone 191, cable television 192, personal digital assistant (PDA, i.e., Blackberry®, Palm® or like device) 193, personal computer 194, and/or mobile telephone 195. Each of NADs 190-195 is adapted to communicate over the network 180 via their respective Access Networks (AN), AN₁ 190₁, AN₂ 191₁, AN₃ 192₁, AN₄ 193₁, AN₅ 194, and AN₆ 195₁, by employing networking methods that are well known to those skilled in the art.

The registration module 120 is adapted to receive user preferences and to store such preferences in a user preferences database 124. The user preferences comprise desired advertising content, and specific network access device information for receiving and displaying the advertising thereon. In this connection, the user can log into a computerized system (i.e. telephone/telephone survey, Internet (IP Network)/web browser, cable television and/or the like) and register their preferences for receiving particular advertising that is made available during a specific broadcast event, and how they would like to receive and have this advertising presented. The user preferences database 124 may contain the following information, including but not limited to: specific advertisement(s), brand name(s), manufacturer(s) and product category(ies) of interest. Additionally, the user preferences database 124 stores specific NAD information that is provided by the user(s), and preferences for displaying the advertising content, and preferred method of message delivery (i.e., make/model of cell phone or PDA, preferred web browser, cable or Internet Protocol (IP) television, etc).

The policy module 130 includes a plurality of rules for the system to match users' preferences with advertising content provided by the media content providers (advertisers) 185. This information is stored in a policy module database 134. The policy module 130 may include an expert rules based distribution engine of the type known to those skilled in the art. In general terms, rules are considered to have two parts: “conditions” and “then” actions. When a “condition” is met either individually or in some combination (according to the logical design), the “then” part of the rule is triggered to take the prescribed action. In an exemplary expedient, the condition part of the rule(s) performs an algorithm incorporating the user preferences and some characteristic or parameter of advertisements stored in a media database 154 (part of the media content module) to yield a decision as to which user will get which advertisement (if any) for presentation on a specified NAD.

The rules engine module 140 performs an algorithm that receives input from the registration module 120, the policy module 130 and the media content module 150. The rules engine module 140 outputs a decision as to which user will receive which advertisement, and in which format. A simple example of this could be two users, the first of which specifies “no food advertisements” and the second specifies “food advertisements”. If a Pizzeria is running a promotion for an upcoming football championship game, the first user who specified “no food advertisements” will not receive a message regarding the promotion, while the second user will as specified in his or her preferences. An example of a Pizzeria's promotion could be a “special” of hot wings, a single topping large pizza and two liter of soda, all for one low price.

The media content module 150 contains database 154 (see above), which includes the media (advertising) content, as provided by the media content provider(s) 185. This may comprise the images, text, layout, scheduling, frequency of distribution, and other characteristics of the particular advertising campaign which is to be distributed to the public during the specified event. Additionally, the format delivery information (how to format the information for each NAD's specific physical characteristics) is included in the database 154.

The message generation module 160 performs an algorithm with input from the rules engine module 140 and the media content module 150. The output of the message generation module is a message ready for delivery which is an advertisement in a specific format for a targeted NAD in accordance with the user preferences.

The message delivery module 170 delivers the message provided by the message generation module 160. Standard methods and techniques for delivery can be utilized in accordance with known techniques.

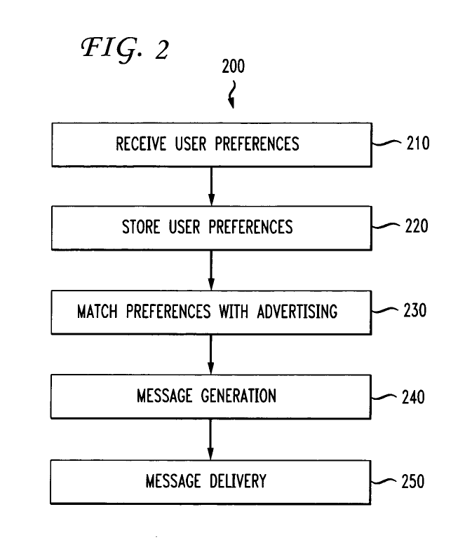

FIG. 2 is a flowchart 200 depicting an exemplary method for practicing an aspect of the present invention. This method starts with step 210, where the user accesses the registration module (see FIG. 1, entity 120) to enter information to be stored in the user preferences database 124 in step 220. This may be accomplished online over an IP network (via web browser input), by telephone, over a cable network, or the like. The user preferences comprise desired advertising content and specific NAD information for receiving and displaying the advertising message content. In step 230 the user preferences are matched to advertising made available for broadcast during the specified broadcast event. As described above, this step is accomplished by the rules engine module (See FIG. 1, entity 140) with input from the registration module (see FIG. 1, entity 120), the policy module (see FIG. 1, entity 130) and the media content module (see FIG. 1, entity 150). In step 240, a message is generated by an algorithm with input from the rules engine module (see FIG. 1, entity 140) and the media content module (see FIG. 1, entity 150). The message may be sent (delivered) immediately to the specified NAD, or stored until such time for a specified delivery time in step 250. The message delivery step communicates one or more advertisements which meet the user preferences over at least one communications network to the at least one NAD specified in the user selected preference(s).

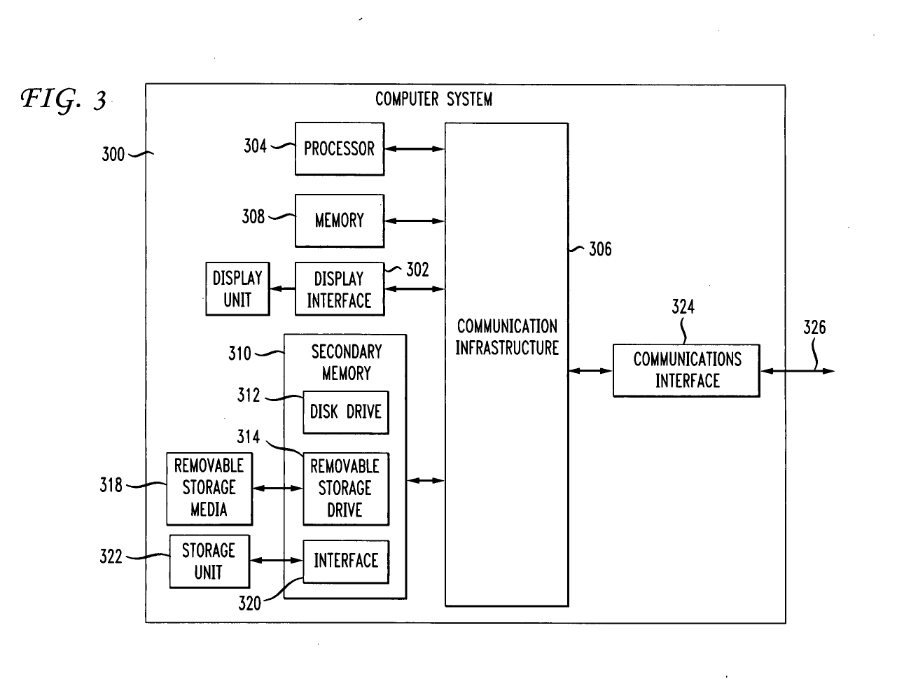

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 300 is shown in FIG. 3. Computer system 300 includes one or more processors, such as processor 304. Processor 304 is connected to a communication infrastructure 306 (e.g., a communications bus, cross-over bar, or network). Computer system 300 can include a display interface 302 (e.g. a graphics card) that allows graphics, text, and other data from the communication infrastructure 306 (or from a frame buffer not shown) to be displayed on a display unit 330. Computer system 300 also includes a main memory 308, preferably random access memory (RAM), and may also include a secondary memory 310. The secondary memory 310 may include, for example, a hard disk drive 312 and/or a removable storage drive 314. The removable storage drive 314 has read/write functionality onto removable storage media 318 having stored therein computer software and/or data. In alternative embodiments, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 322 and interfaces 320, which allow software and data to be transferred from the removable storage unit 322 to computer system 300. Computer system 300 may also include a communications interface 324 allowing software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals (not shown), which may be electronic, electromagnetic, optical or other signals capable of being received by communications interface 324. These signals are provided to communications interface 324 via a communications path (e.g., channel) 326. This path 326 carries the signals and may be implemented using wire or cable, fiber optics, a telephone line, a cellular link, a radio frequency (RF) link and/or other communications channels. Computer programs (also referred to as computer control logic) are stored in main memory 308 and/or secondary memory 310. Computer programs may also be received via communications interface 324. Computer programs, when executed, enable the computer system 300 to perform the features of the present invention, as discussed herein. Accordingly, such computer programs represent controllers of the computer system 300. In an embodiment where the invention is implemented using software, the software may be stored in a computer program product and loaded into computer system 300 using removable storage drive 314, hard drive 312, or communications interface 324. The control logic (software), when executed by the processor 304, causes the processor 304 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s). In one exemplary embodiment, the system for the present invention may be implemented, for example, as a Microsoft.net® desktop application program (Microsoft.net® is made by Microsoft® Corporation of Redmond, Wash.), which may reside on a computer hard drive, database or other repository of data, or be uploaded from the Internet or other network (e.g., from a PC, minicomputer, mainframe computer, microcomputer, telephone device, PDA, or other NAD having a processor and input and/or output capability). Any available software tool capable of implementing the concepts described herein may be used to implement the system and method of the present invention. The method and system of the present invention may also be implemented as an application-specific add-on to a program, or as a standalone application.

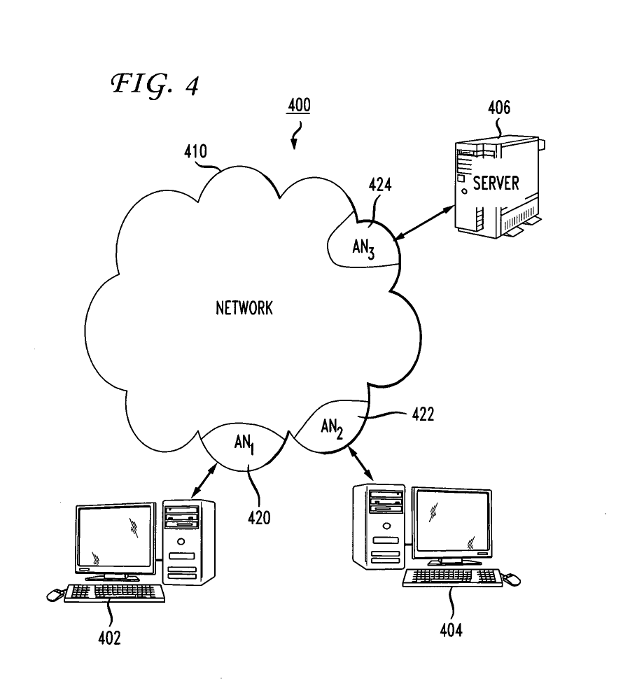

As shown in FIG. 4, in an embodiment of the present invention, some data for use in the system is, for example, input by one or, more Network Access Devices (NADs) such as NAD 402 and NAD404, among a plurality of NADs via, for example, a network 410, such as the Internet or-an intranet, and access networks (ANs) AN₁ 420, AN₂ 422 and AN₃ 424. The ANs may include, for example, wired, wireless, or fiberoptic links. Examples of such NADs include a personal computer, laptop computer, minicomputer, mainframe computer, microcomputer, telephonic device, or wireless device, such as a hand-held wireless device. These NADs communicate over the communications network 410 to a server 406 (or network of server computers) that implements the functionality above. Server 406 may also be considered to be a NAD, having a processor and a repository for data and/or connection to a processor and/or repository for data.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

We claim:

1. A method for providing advertising to users over at least one communications network during a specified broadcast event based on user preferences, comprising the steps of:
receiving user preferences comprising desired advertising content, and specified network access device information for receiving and displaying the advertising thereon;
storing the user preferences in a database;
matching the user preferences with advertising content by at least one advertiser during the specified broadcast event; and
communicating advertising content which meet the user preferences over at least one communications network to at least one network access device specified in the user selected preferences.

2. The method of claim 1, further comprising the step of receiving the advertising content from at least one advertiser.

3. The method of claim 1, wherein the user preferences are stored in a registration database.

4. The method of claim 3, wherein a rules engine matches the user preferences with the advertising content, and formats an advertisement for the network access device specified in the user preferences.

5. The method of claim 1, wherein the user preferences includes one or more of the following: specific advertisement, brand name, manufacturer, and product category.

6. The method of claim 1, wherein the user preferences are specified via a web browser.

7. The method of claim 1, wherein the user preferences are specified via a telephone survey.

8. The method of claim 1, wherein the user preferences are specified through a cable network.

9. The method of claim 1, wherein the user preferences are specified through an Internet Protocol (IP) network.

10. A system for providing advertising to networked users during a specified broadcast event based on user preferences, comprising:
a computing device coupled to at least one communications network and adapted for:
receiving user preferences comprising desired advertising content, and specified network access device information for receiving and displaying the advertising thereon;
storing the user preferences in a database;
matching the user preferences with advertising content by at least one advertiser during the specified broadcast event; and
communicating advertising content which meet the user preferences over at least one communications network to at least one network access device specified in the user selected preferences.

11. The system of claim 10, further comprising a media content database adapted for storing advertising content from at least one advertiser.

12. The system of claim 10, further comprising a registration database for storing the user preferences.

13. The system of claim 12, further comprising a rules engine adapted for matching the user preferences with the advertising content and formatting an advertisement for the network access device specified in the user preferences.

14. The system of claim 10, wherein the user preferences includes one or more of the following: specific advertisement, brand name, manufacturer, and product category.

15. The system of claim 10, wherein the user preferences are specified via a web browser.

16. The system of claim 10, wherein the user preferences are specified via a telephone survey.

17. The system of claim 10, wherein the user preferences are received over a cable network.

18. The system of claim 10, wherein the user preferences are received over an Internet Protocol (IP) network.

19. The system of claim 10, wherein the user preferences are received over a cellular network.

20. A system for providing advertising to networked users during a specified broadcast event based on user preferences, comprising:
a computing device coupled to at least one communications network and adapted for:
receiving user preferences comprising desired advertising content, and specified network access device information for receiving and displaying the advertising thereon;
storing the user preferences in a database;
receiving advertising content from at least one advertiser;
matching the user preferences with advertising content by the at least one advertiser during the specified broadcast event with a rules engine adapted for matching the user preferences with the advertising content and formatting an advertisement for the network access device specified in the user preferences; and
communicating advertising content which meet the user preferences over at least one communications network to at least one network access device specified in the user selected preferences.
